(19) United States
(12) Patent Application Publication
(10) Pub. No.: US 2016/0353654 A1
(43) Pub. Date: Dec. 8, 2016

(54) Flat Fold Cultivator Marker

(71) Applicants: David Lawrence Maach, Grand Junction, IA (US); Kelley Mathew Kokemiller, Grand Junction, IA (US)

(72) Inventors: David Lawrence Maach, Grand Junction, IA (US); Kelley Mathew Kokemiller, Grand Junction, IA (US)

(21) Appl. No.: 15/170,118

(22) Filed: Jun. 1, 2016

Related U.S. Application Data
(60) Provisional application No. 62/170,417, filed on Jun. 3, 2015.

(51) Int. Cl. A01B 63/32; A01B 69/02

(52) U.S. Cl. CPC A01B 63/32; A01B 69/02; A01B 69/024; A01B 5/04

(57) ABSTRACT

An agriculture cultivator marker to make a soil furrow during the last pass of field preparation prior to planting. The furrow mark is centered on the cultivator. The tractor with planting implement then centers on the marked soil furrow to ease the process of planting close to field edges and obstacles. The arm holding the cultivator marker rotating disk is adjustable for accurate soil contact. The cultivator marker arm and rotating disk fold flat when not in use to avoid interference with surroundings.

### CROSS-REFERENCE TO RELATED APPLICATIONS

This application claims priority to U.S. Provisional Patent Application Ser. No. 62/170,417 filed Jun. 3, 2015, titled “Flat Fold Cultivator Marker”, the entire contents of which is incorporated herein, both bodily and by reference.

### FEDERALLY SPONSORED RESEARCH

Not Applicable

### SEQUENCE LISTING OR PROGRAM

Not Applicable

### FIELD OF THE INVENTION

The present invention relates to an agriculture cultivator marker and, more particularly, to a flat fold cultivator marker.

### BACKGROUND OF THE INVENTION

A commodity farmers revenues are a result of their crop yield times the total area in production. As a result they must take advantage of as much area as possible within their fields. This involves planting as close to perimeter boundaries such as fences, trees and other obstacles. When planting their crops, care must be taken to not strike these obstacles with their seeding implements. This task becomes harder as the width of the seeding implement increases, making it harder for the operator to judge the distance between the edge of the implement and the surrounding obstacles. As can be seen, there is a need for an improved cultivator marker.

### SUMMARY OF THE INVENTION

The present invention includes a flat fold cultivator marker. The present invention aids the operator of the seeding implement by giving them a mark or furrow in the soil to follow when planting. The operator utilizes a seeding implement with the same width (or slightly smaller width if a clearance is desired) as the cultivator. The operator then only needs to concentrate on keeping the tractor and seeding implement centered on this mark instead of trying to judge clearances with outlying obstacles. The present invention places a mark in the soil while doing secondary tillage operations. These secondary tillage operations are done before planting in order to prepare the soil for planting. The present invention provides a better quality mark in the soil than current devices. The present invention also folds up when not in use allowing it to not interfere with the tillage implement or surroundings.

### BRIEF DESCRIPTION OF THE DRAWINGS

FIG. 1 is view of the marker arm installed on a cultivator.

FIG. 2 is a right side isometric view of the marker arm in extended position.

FIG. 3 is a left side isometric view of the marker arm in extended position.

FIG. 4 is a side view of the marker arm in extended position.

FIG. 5 is a top view of the marker arm in extended position taken along view lines A-A from FIG. 4.

FIG. 6 is a bottom view of the marker arm in extended position taken along view lines B-B from FIG. 4.

FIG. 7 is an end view of the marker arm in extended position taken along view lines C-C from FIG. 4.

FIG. 8 is a right side isometric view of the marker arm in halfway position.

FIG. 9 is a left side isometric view of the marker arm in halfway position.

FIG. 10 is an enlarged left side isometric view of the marker arm in halfway position taken from FIG. 9.

FIG. 11 is a right side isometric view of the marker arm in retracted position.

FIG. 12 is a left side isometric view of the marker arm in retracted position.

FIG. 13 is a left side isometric view of the rolling basket mount marker arm in extended position.

FIG. 14 is a right side isometric view of the rolling basket mount marker arm in extended position.

REFERENCE NUMERALS

| | |
|---|---|
| 5 tillage implement | 6 hitch |
| 7 marker arm | 8 furrow |
| 10 disk blade | 11 axle bracket |
| 12 inner arm | 15 arm bracket |
| 16 base | 17 outer arm |
| 18 swival mount | 19 arm clamp |
| 21 linkage arm | 22 hydraulic cylinder |
| 23 hard stop | 25 pivot pin |
| 27 base pin | 29 arm pin |
| 31 shaft bracket | 33 shaft pin |
| 35 cylinder shaft | 37 cylinder pin |
| 39 harrow bar | 41 roller mount |
| 43 mounting pocket | 45 geometric centerline |

### DETAILED DESCRIPTION OF THE DRAWINGS

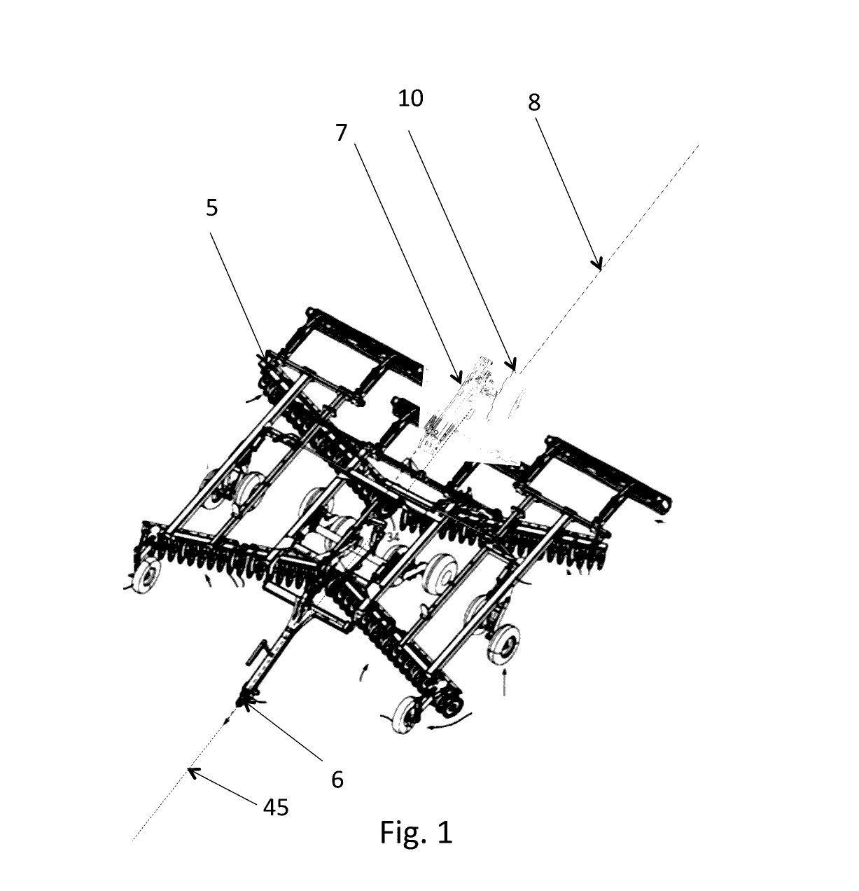

FIG. 1 is view of the marker arm 7 installed on a tillage implement 5. The tillage implement 5 would be pulled with a tractor via the hitch 6. The marker arm 7 is mounted to the tillage implement 5 in a position with the disk blade 10 on the tillage implement 5 centerline. The marker arm 7 when extended places a furrow 8 in the soil via a rotating disk blade 10.

Geometric centerline is a term used in automotive engineering and is a line drawn from the center of the rear axle through the center of the front axle. This term is used in this disclosure with some adjustment for application to a pulled tillage implement 5.

The geometric centerline 45 of the tillage implement 5 is a horizontal line that extends through the hitch 6 and along the front to rear direction of the implement. The furrow 8 and disk blade 10 are vertically under the geometric centerline 45.

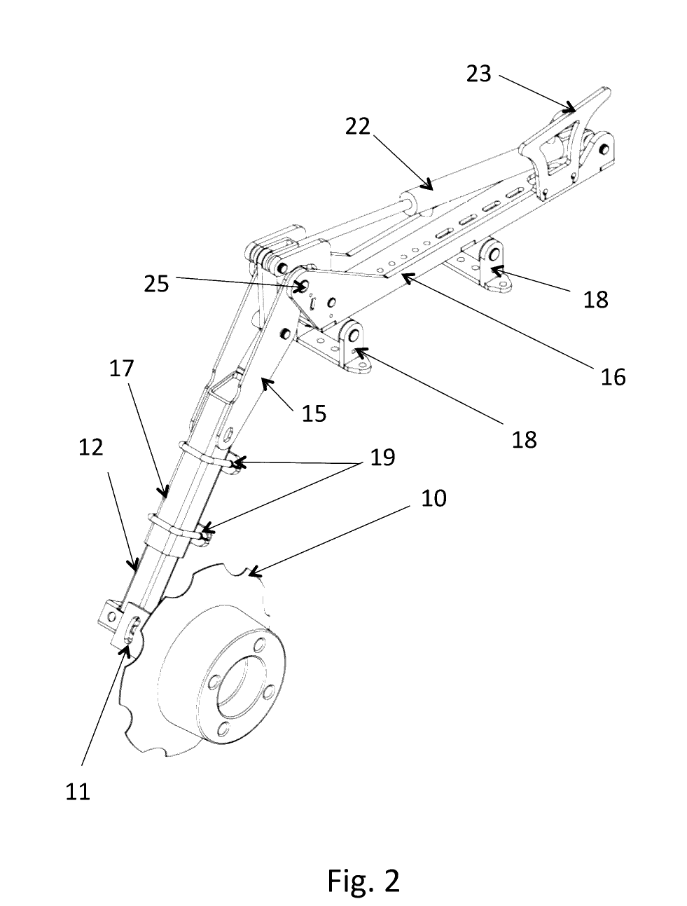

FIG. 2 is a right side isometric view of the marker arm 7 in extended position. The disk blade 10 is attached to an axle bracket 11 which is attached to an inner arm 12. The inner arm 12 telescopes within the outer arm 17 and is affixed with the arm clamps 19.

The outer arm 12 is affixed to the arm bracket 15. The arm bracket 15 rotates about a pivot pin 25 on the base 16 via a hydraulic cylinder 22.

The base 16 mounts to the tillage implement 5 via a pair of swiveling mounts 18. The swivel mounts 18 may be equal length so as each swivel mount 18 may rotate, the base 16 will remain horizontal.

The swivel mounts 18 use a parallel arm design to keep the main structure base 16 horizontal with the ground at all times. This is important in transport position to keep a low profile. This is important in the field position to keep the disk blade 10 consistently engaged with the soil.

The hard stop 23 is affixed to the base 16.

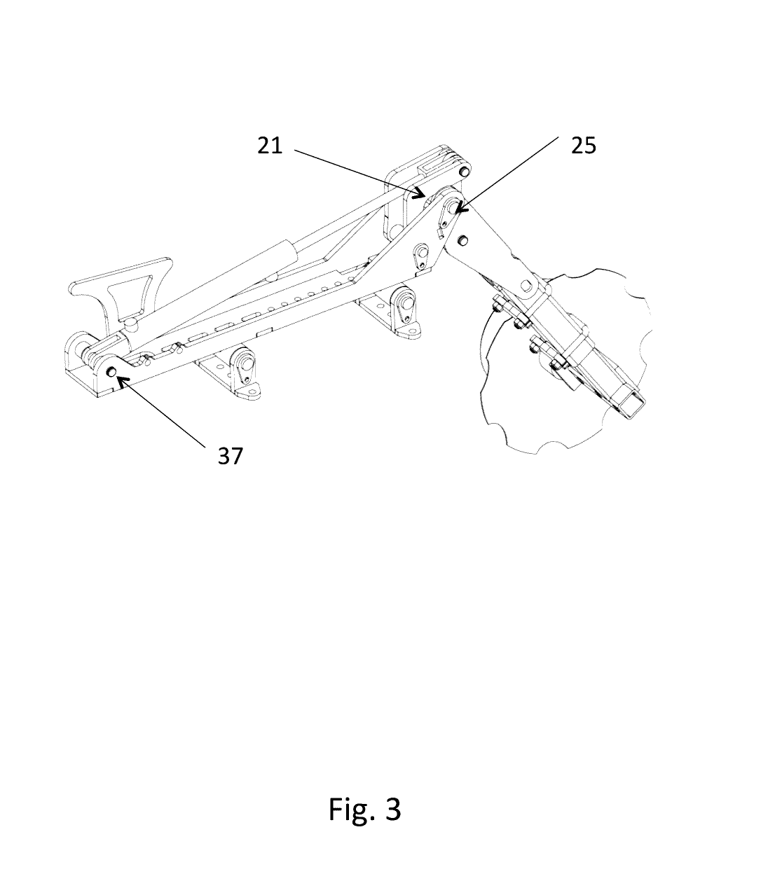

FIG. 3 is a left side isometric view of the marker arm 7 in extended position. The cylinder pin 37 allows rotational movement between the hydraulic cylinder 22 and base 16.

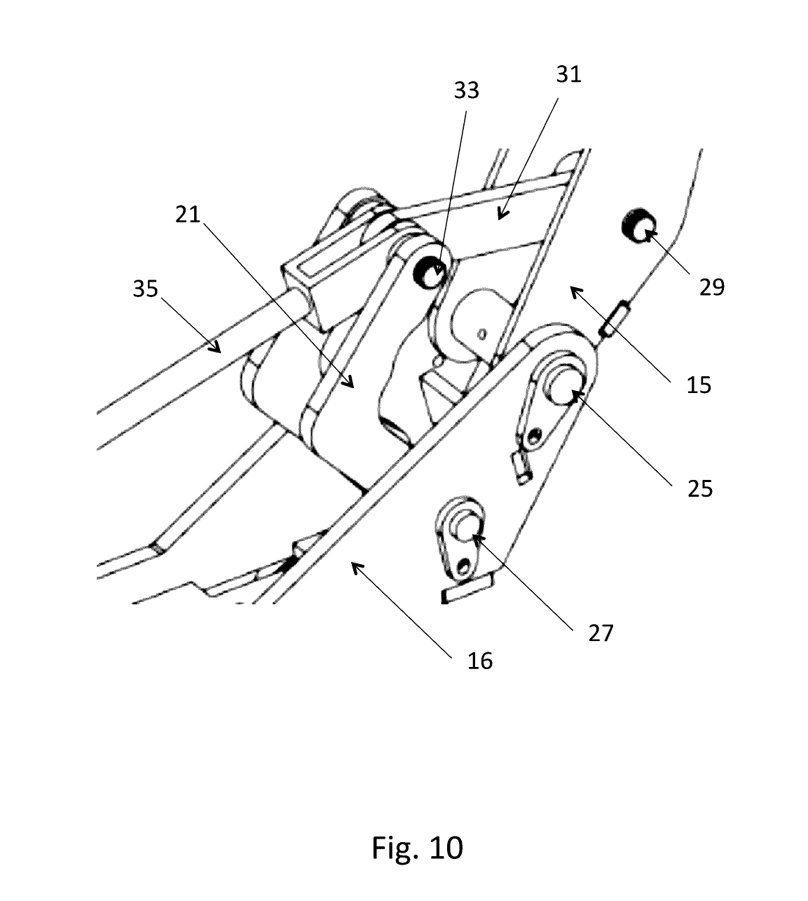

To provide a limit for movement toward the extended position, the linkage arm 21 contacts the pivot pin 25. The detail of how these parts interact can also be seen in FIG. 10 in the halfway position before they contact.

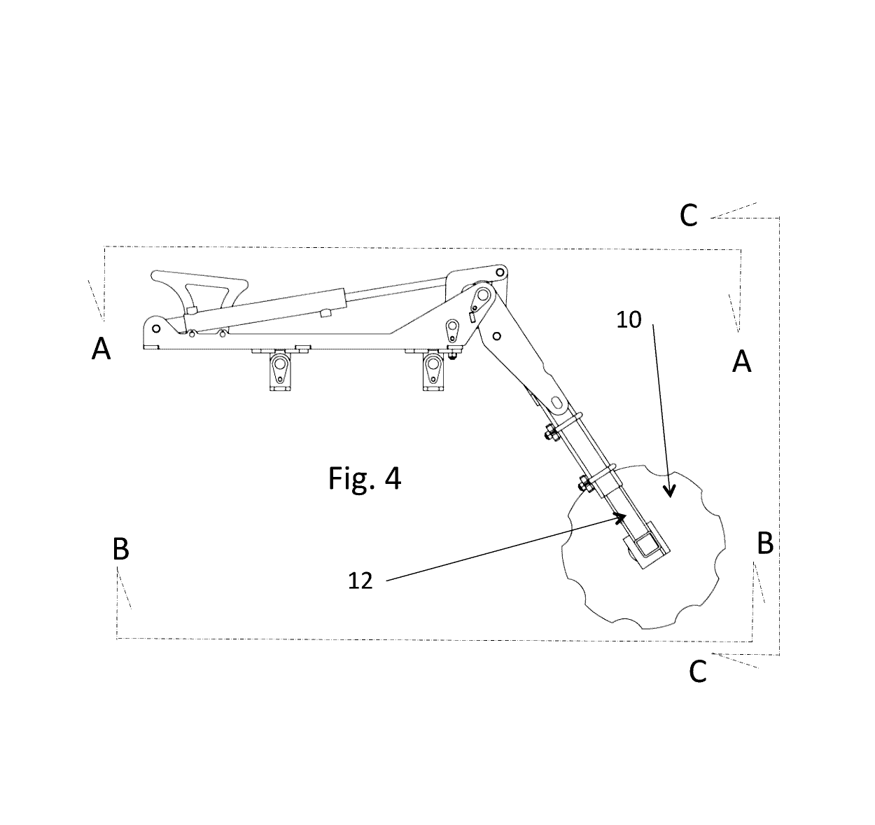

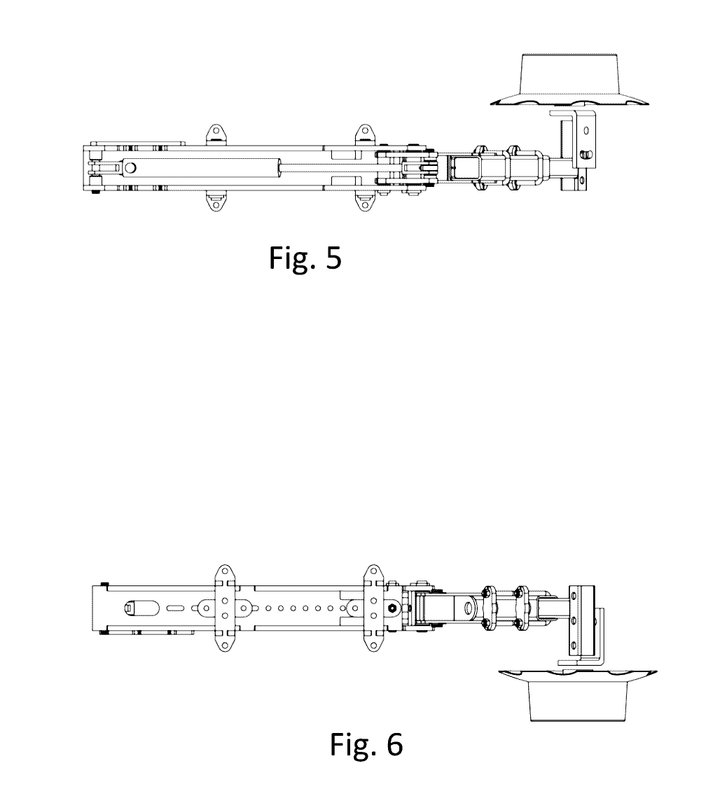

FIG. 4 is a side view of the marker arm in extended position. The telescoping design allows for infinite length increments of the inner arm 12. This ensures the correct length can be achieved to keep the disk blade 10 engaged with the soil during operation.

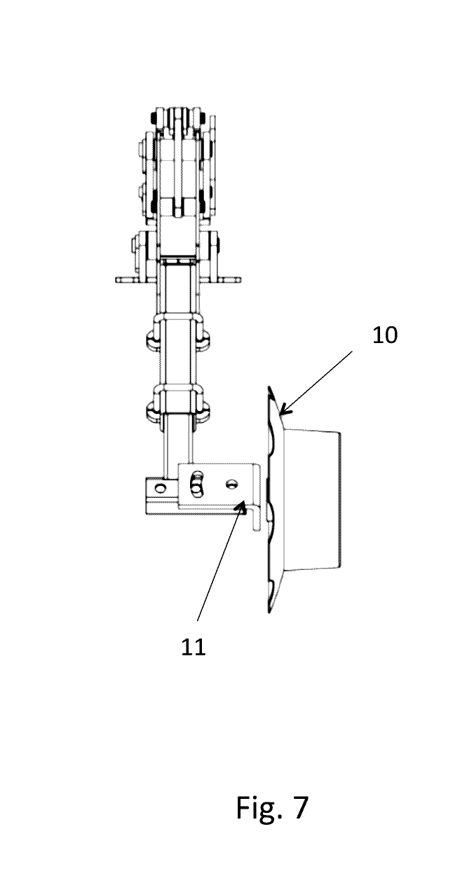

FIG. 7 is an end view of the marker arm in extended position taken along view lines C-C from FIG. 4. The disk blade 10 attachment to the axle bracket 11 is shown.

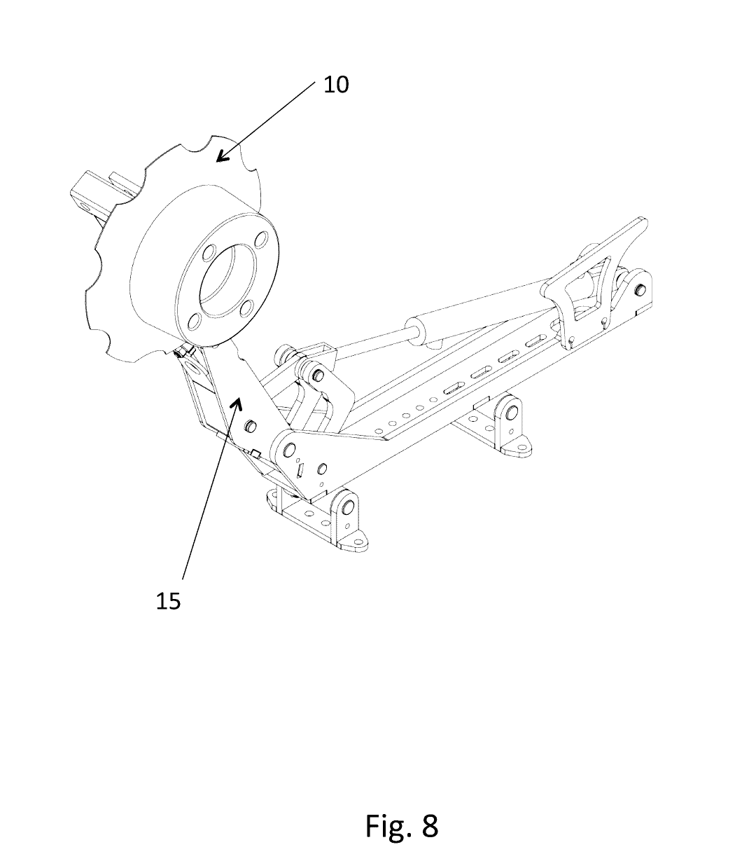

FIG. 8 is a right side isometric view of the marker arm in halfway position. This position of the disk blade 10 would be used when traversing a field and a marker furrow 8 is not desired.

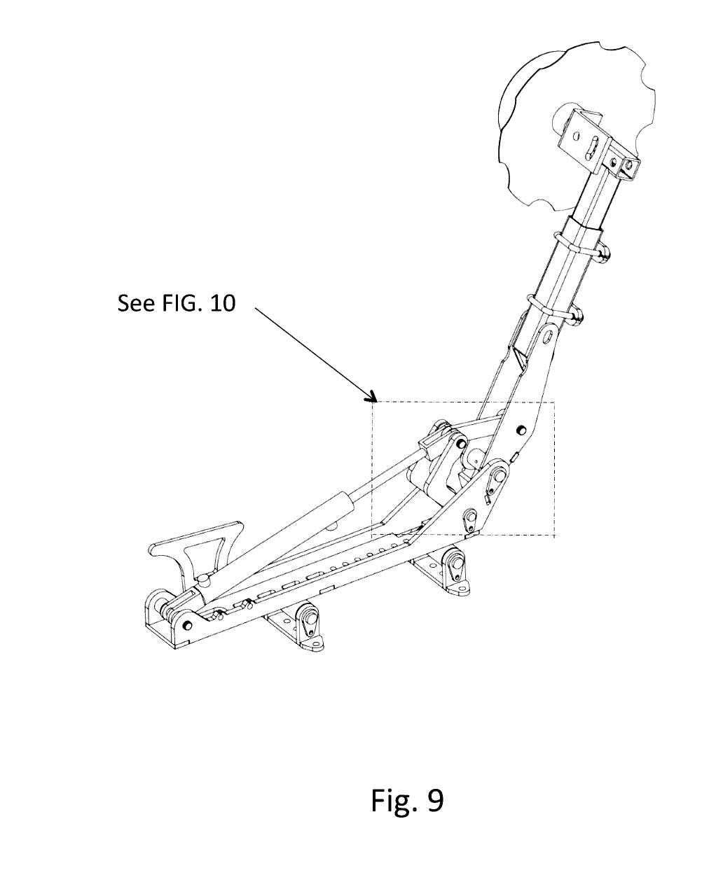

FIG. 10 is an enlarged left side isometric view of the marker arm in halfway position taken from FIG. 9. The motion of the arm bracket 15 is controlled with a four bar linkage. The four bars include base 16, arm bracket 15, shaft bracket 31 and the linkage arm 21. The four pivot points include base pin 27, shaft pin 33, arm pin 29 and the pivot pin 25.

The base 16 is the fixed bar of the linkage. The cylinder shaft 35 provides the input to the linkage via the shaft pin 33. The arm bracket 15 is the output of the linkage.

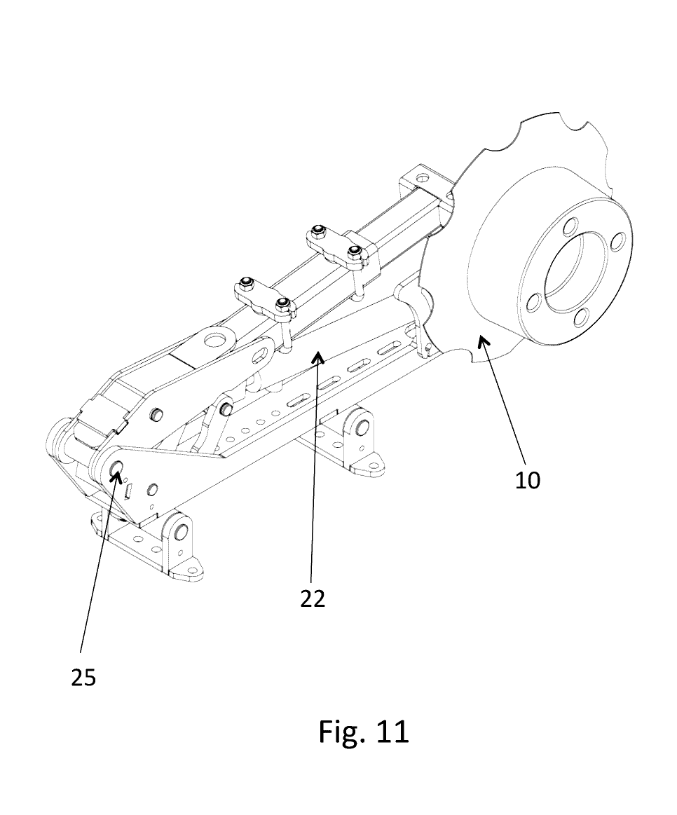

FIG. 11 is a right side isometric view of the marker arm in retracted position. The present invention has multiple positions. The retracted position is when the disk blade 10 is not engaged with the soil. The extended position is when the disk blade 10 is engaged with the soil. The pivot pin 25 and the hydraulic cylinder 22 allow the device to flat fold into a low profile when in retracted position. The swivel mounting base and the adjustable length arm ensure the disk blade 10 is always making proper contact with the soil when the invention is in the extended position.

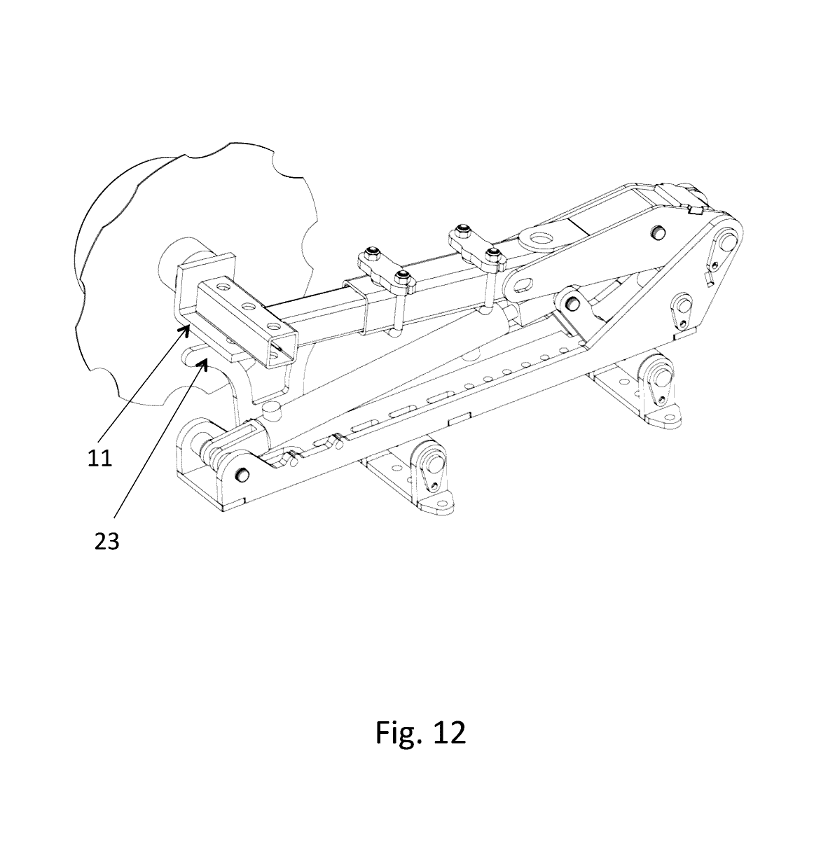

FIG. 12 is a left side isometric view of the marker arm in retracted position. To provide a limit for movement toward the retracted position, the axle housing 11 contacts the hard stop 23. The low profile element of the design allows the device to not interfere with its surroundings when not in use.

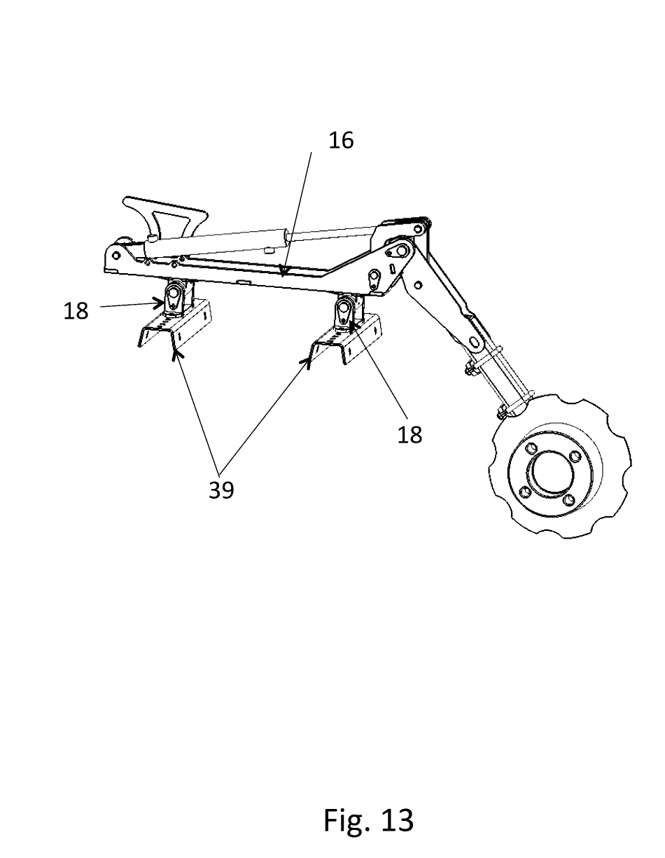

FIG. 13 is a left side isometric view of the harrow mount marker arm in extended position. The harrow bars 39 are part of the tillage implement 5. Each harrow bar 39 is attached to the lower portion of the swivel mount 18. In this configuration, each harrow bar 39 can independently rotate without impacting the horizontal level of the base 16.

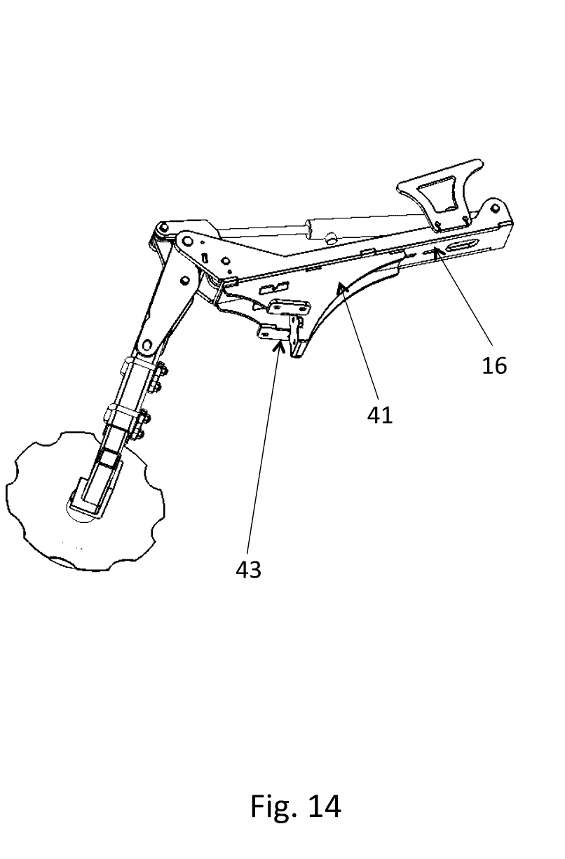

FIG. 14 is a right side isometric view of the rolling basket mount marker arm in extended position. In this configuration, no swivel mounts 18 are used. The roller mount 41 is affixed to the base 16. The mounting pocket 43 on the roller mount 41 is affixed to a bar on the tillage implement 5.

The finished device may include several painted weldments, attaching hardware and a hydraulic cylinder 22 and hoses. The painted weldments start out as individual steel plates and structural tube parts which are produced with equipment such as plate lasers and CNC lathes and mills. The parts are positioned in a welding fixture and joined via a GMAW (MIG welding) process. After welding, the parts are either painted or zinc plated to inhibit oxidation (rust). A hydraulic cylinder 22 acts as the actuator. Standard hardware is used to retain the components.

A method of using the present invention may include the following. The marker arm 7 is attached to the tillage implement 5. Once mounted, then the desired inner arm 12 position can be adjusted to ensure proper contact of the disk blade 10 with the soil. Hydraulic lines would be run from the tractor to the hydraulic cylinder 22. The device can then be operated from the tractor by the operator via only the hydraulic remote control. The hydraulic remote actuates the cylinder shaft 35, which takes the device from the “folded” or “retracted” state to the “field” or “extended” state. The operator engages the hydraulic remote until the cylinder shaft 35 fully takes the device from one state to the next. Hard stops are present on the device to prevent against damage from over extending the device in either state.

Although the invention has been described in terms of specific embodiments and applications, persons skilled in the art can, in light of this teaching, generate additional embodiments without exceeding the scope or departing from the spirit of the claimed invention. Accordingly, it is to be understood that the drawings and description in this disclosure are provided to help the reader understand the invention, and do not limit the scope of the claims.

The invention claimed is:

1. A tillage implement apparatus comprising:
a disk for marking a line in a soil;
an arm with adjustable length;
a first end of the arm connected to the disk;
a second end of the arm connected to a means for pivoting the arm about a base;
the base is connected to the tillage implement; and
the disk is positioned vertically under a geometric centerline of the tillage implement.

2. The apparatus of claim 1 wherein the disk rotates when in contact with the soil.

3. The apparatus of claim 1 wherein the means for pivoting includes a hydraulic cylinder.

4. The apparatus of claim 1 wherein the base is connected to the tillage implement via a swivel base.

5. The apparatus of claim 1 wherein the base is connected to the tillage implement via a single mounting pocket

6. The apparatus of claim 3 wherein the means for pivoting further includes a four bar linkage.

7. The apparatus of claim 3 wherein the means for pivoting folds the arm to within 5 degrees of a horizontal storage position.

8. The apparatus of claim 6 wherein the means for pivoting further includes a means for hard stop at a retract end of the hydraulic cylinder travel and a second means for hard stop at an extend end of the hydraulic cylinder travel.

9. A tillage implement apparatus comprising:
a disk which rotates on an axle for marking a line in soil;
an arm with adjustable length;
a first end of the arm connected to the axle;
a second end of the arm connected to a means for pivoting the arm about a base;
the base is connected a swivel;
the swivel is connected to the tillage implement; and
the disk is positioned under a geometric centerline of the tillage implement.

10. The apparatus of claim 9 wherein the disk rotates when in contact with the soil.

11. The apparatus of claim 9 wherein the means for pivoting includes a hydraulic cylinder.

12. The apparatus of claim 11 wherein the means for pivoting further includes a four bar linkage.

13. The apparatus of claim 12 wherein the means for pivoting folds the arm to within 5 degrees of a horizontal storage position.

14. The apparatus of claim 12 wherein the means for pivoting further includes a means for hard stop at a retract end of the hydraulic cylinder travel and a second means for hard stop at an extend end of the hydraulic cylinder travel.

15. A method of marking a line in a soil, the method comprising:
connecting a tillage implement to a tractor;
pulling the tillage implement with the tractor;
providing a base connected to the tillage implement;
adjusting a length of an arm;
pivoting the arm about the base;
providing a disk connected to the arm; and
marking the line in the soil with the disk vertically under a geometric centerline of the tillage implement.

16. The method of claim 15 further comprising pivoting the arm to within 5 degrees of a horizontal storage position.

17. The method of claim 15 wherein the arm is pivoted with a hydraulic cylinder.

18. The method of claim 15 wherein the motion of the arm is controlled with a four bar linkage.

19. The method of claim 15 wherein the base is connected to the tillage implement via a swivel base.

20. The method of claim 15 wherein the disk rotates when marking the line in the soil.
